(19) United States
(12) Patent Application Publication
(10) Pub. No.: US 2007/0280737 A1
(43) Pub. Date: Dec. 6, 2007

(54) Device And Method For Developing Potential Images Previously Created On A Potential Image Support And Containing The Images That Are To Be Printed In An Electrographic Printing Or Copying Apparatus

(75) Inventors: Martin Berg, Munchen (DE); Volkhard Maess, Pliening (DE); Martin Schleusener, Namborn (DE)

Correspondence Address: SCHIFF HARDIN, LLP;PATENT DEPARTMENT, 6600 SEARS TOWER, CHICAGO, IL, 60606-6473, US

(73) Assignee: OCE PRINTING SYSTEMS GMBH, Poing (DE)

(21) Appl. No.: 11/631,371

(22) PCT Filed: Jul. 1, 2005
(86) PCT No.: PCT/EP05/07101

§ 371 Date: Jul. 23, 2007

(30) Foreign Application Priority Data
Jul. 7, 2004 (DE) 10 2004 032 922.2

(51) Int. Cl. G03G 15/10

(52) U.S. Cl. 399/240

(57) ABSTRACT

In a method or device for development of potential images previously generated on a potential image carrier, the potential images comprising images to be printed as image locations, in an electrophotographic printing or copying device, an applicator roller directs a liquid developer comprising carrier fluid and toner particles onto the potential image carrier for inking of the image locations of the potential images such that a developer gap provided between the potential image carrier and the applicator rollers is substantially filled. A proportion of the toner particles is mixed with the carrier fluid with a viscosity between 0.1 to 80 mPa*s using a dispersion promoting additive such that the liquid developer has a viscosity between 1-99 mPa*s, so that the toner particles dispersed in the liquid developer in a region of the image locations of the potential images migrate onto. the potential image carrier and no toner particles migrate in regions that are not to be developed.

### BACKGROUND

For single-color or multicolor printing of a recording medium, for example of a single sheet or of a band-shaped recording medium made of the most varied materials (for example paper or thin plastic or metal films), it is known to generate image-dependent print images (charge images) on a potential image carrier (for example a photoconductor), which image-dependent print images correspond to the images to be printed comprising regions to be inked and regions that are not to be inked. The regions (called image locations in the following) of the potential images to be inked are made visible via toner with a developer station (inking station). The toner image is subsequently transfer-printed onto the recording medium.

One method for electrophoretic liquid development (electrophotographic development) in digital printing systems is, for example, known from EP 0 756 213 B1 or EP 0 727 720 B1. The method described there is also known under the name HVT (high viscosity technology). A carrier liquid containing silicon oil with ink particles (toner particles) dispersed therein is thus used as a liquid developer. The toner particles typically have a particle size of less than 1 micron. More detail in this regard can be learned from EP 0 756 213 B1 or EP 0 727 720 B1, which are a component of the disclosure of the present application. Electrophoretic liquid development methods of the cited type with silicon oil as a carrier liquid with toner particles dispersed therein are described there, in addition to a developer station made from one or more developer rollers for wetting of the image carrier element with liquid developer corresponding to the potential images on the potential image carrier. The inked potential image is then transferred onto the recording medium via one or more transfer elements (for example rollers or belts).

A liquid developer with a carrier fluid (for example silicon oil) and toner particles dispersed therein is used in EP 0 727 720 B1. The liquid developer exhibits a viscosity of 100-10,000 mPa*s. This high viscosity is required in order to enable a high proportion of toner particles in the liquid developer since only then is a sufficient inking of potential images on the potential image carrier to be achieved. It is additionally necessary that parting liquid is applied to the potential image carrier before the developer station, which parting liquid mixes with the liquid developer in the developer station. The high viscosity of the liquid developer has the disadvantage that the toner particles move relatively slowly in the carrier fluid.

A liquid developer made up of a curable fixing agent and colorant results from DE 691 25 748 T2. The fixing agent should exhibit a viscosity of not more than 500 mPa*s and a specific resistance of not less than 10⁸ Ωcm. Furthermore, the fixing agent should comprise at least approximately 80% by weight of the liquid component of the developer. In contrast to the method cited above, here the fixing agent must be cured in order to permanently bond the colorant with a recording medium. One disadvantage of this liquid developer is to be seen in that the mobility of the colorant in the fixing agent is relatively small and the printing speed is therewith correspondingly low.

### SUMMARY

It is an object to specify a device and a method with which a liquid developer is supplied to a potential image carrier such that a constant inking of the potential image carriers comprising the image locations present there is achieved at high print speed.

In a method or device for development of potential images previously generated on a potential image carrier, the potential images comprising images to be printed as image locations, in an electrophotographic printing or copying device, an applicator roller directs a liquid developer comprising carrier fluid and toner particles onto the potential image carrier for inking of the image locations of the potential images such that a developer gap provided between the potential image carrier and the applicator rollers is substantially filled. A proportion of the toner particles is mixed with the carrier fluid with a viscosity between 0.1 to 80 mPa*s using a dispersion promoting additive such that the liquid developer has a viscosity between 1-99 mPa*s, so that the toner particles dispersed in the liquid developer in a region of the image locations of the potential images migrate onto the potential image carrier and no toner particles migrate in regions that are not to be developed.

### BRIEF DESCRIPTION OF THE DRAWINGS

FIG. 1 is a principle representation of a printing or copying device with which a liquid development can be implemented;

FIG. 2 is a first embodiment of a developer station; and

FIG. 3 is a second embodiment of a developer station.

### DESCRIPTION OF THE PREFERRED EMBODIMENT

For the purposes of promoting an understanding of the principles of the invention, reference will now be made to the preferred embodiment illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

The use of a low-viscosity carrier fluid (and correspondingly of a low-viscosity liquid developer that exhibits a high weight proportion of toner particles) leads to a high mobility of the toner particles in the carrier fluid given high electrical field forces in the developer gap between potential image carrier and applicator roller, and thus to a secure deposition of the toner particles, whereby a constant inking of the image locations of the potential image carrier is achieved for high print speeds (some meters per second).

In order to achieve a high mobility of the toner particles in the carrier fluid, the entirety made up of carrier fluid and toner particles is executed such that the liquid developer exhibits a low viscosity. This can advantageously be influenced in that dispersion-promoting additives are added.

A further advantage is to be seen in that only a carrier fluid (thus no parting fluid) is used. This avoids a contamination of the circulating liquid developer in the developer station and cleaning stations (possibly used). The reusability of the carrier fluid in the cyclical process is thus increased.

It is advantageous when the carrier fluid exhibits a viscosity of 0.1 to 80 mPa*s, and is additionally high-ohmic, for example has a specific resistance >=10¹⁰ Ω*cm. A carrier fluid that satisfies these requirements can be silicon oil. For example, the silicon oil can comprise polydimethylsiloxane.

When a nonvolatile liquid is selected as a carrier fluid a stress of the environment is avoided. The same result can be achieved when a volatile carrier fluid is subjected to a treatment before or after the printing process such that it becomes nonvolatile. This can, for example, be achieved in that the carrier fluid is exposed with UV light. A fluid that can be hardened via UV light is, for example, acrylester. A further possibility of such a treatment can occur with additional substances that transform the image on the recording medium such that no volatile substances remain therein or can escape from this, for example via polycondensation via moisture, for example from the air.

In order to obtain a good inking on the potential images on the potential image carrier, the proportion of toner particles in the developer liquid should be selected between 10-55% by weight and the average value of the volume-weighted diameter distribution of the toner particles should lie in the range from 0.1 to 5 μm, advantageously 0.5 to 2 μm.

In order to achieve a further improvement of the inking of the potential images, the applicator roller can be arranged relative to the potential image carrier such that a developer gap between applicator roller and potential image carrier is created that exhibits a film thickness of 1-20 μm filled with liquid developer.

A further possibility of the establishment of the film thickness of the developer gap between applicator roller and potential image carrier exists in the arrangement of spacing elements. Distance rings that are in contact with the potential image carrier can be arranged on the applicator roller for this. Or prism-like sliding elements that are in contact with the potential image carrier can be arranged on the applicator roller. Finally, air bearings can be provided between applicator roller and potential image carrier as spacing elements.

When the developer gap and the liquid developer are selected in such a manner, the toner particles dispersed in the liquid developer completely or nearly completely migrate to the potential image carrier in the region of the image locations of the potential image carrier; and only a few toner particles migrate in the regions without image locations.

The movement directions of the surfaces of potential image carrier and applicator roller can run in the same direction or in contrary directions for inking; and they can run with the same or different surface velocities.

The migration of the inked potential images from the potential image carrier onto an image carrier and/or recording medium can occur in mechanical context between potential image carrier and image carrier/recording medium.

In order to supply the applicator roller with liquid developer, it is appropriate to arrange a raster roller adjacent to the applicator roller, which raster roller lies adjacent to a chamber scraper that supplies the liquid developer to the raster roller. The quantity of the conveyed liquid developer can then be influenced via the rastering of the raster roller. The advantage of such a conveyance system made up of chamber scraper and raster roller is to be seen in that the transport of the liquid developer via the raster roller is surface-related and thus independent of the print speed, such that at different print speeds the same quantity of liquid developer per areal unit is always directed onto the developer roller. The raster roller can thus exhibit a rastering that enables the conveyance of a volume of liquid developer of 1 to 40 cm³/m² (relative to the roller surface), advantageously 5 to 20 cm³/m².

However, a different conveyance system is possible in that the liquid developer is supplied to the raster roller via a scoop roller.

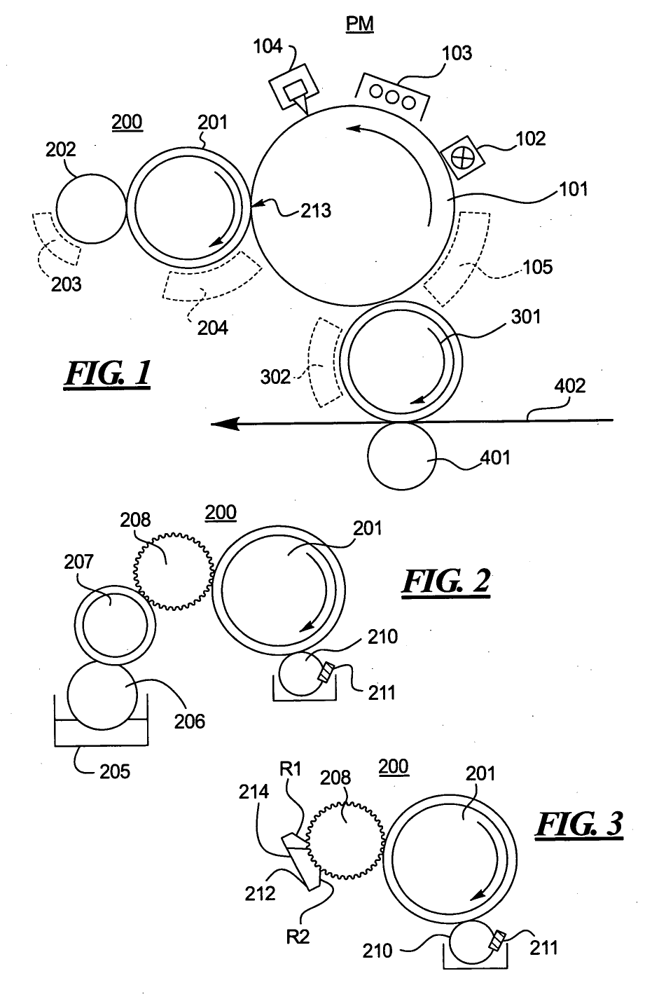

A principle representation of an electrographic printing module PM results from FIG. 1. A potential image carrier 101 (for example a photoconductor drum) is initially subjected to a wiping exposure 102. The charging of the potential image carrier 101 subsequently occurs in a station 103. Potential images with image locations of images to be printed are generated on the potential image carrier 101 via image-proportional exposure in the station 104. These potential images are inked in a developer station 200 via a liquid developer with the aforementioned properties. For this liquid developer is extracted from a developer reservoir 203 and is supplied to an applicator roller 202. The applicator roller 202 conveys the liquid developer to an applicator roller 201 and this conveys the liquid developer to the potential image carrier 101. The applicator roller 201 is subsequently cleaned in the cleaning station 204.

Given the inking of the potential images onto the potential image carrier 101, toner particles in the regions comprising image locations migrate onto the potential image carrier 101 and accumulate there; to the contrary, nearly no migration of toner particles onto the potential image carrier 101 occurs in the non-image regions.

In a transfer printing station with an image carrier 301 the inked potential images (toner images) are transferred onto a recording medium 402. A counter-pressure roller 401 is additionally used for this. The image carrier 301 can additionally be cleaned with the aid of an image carrier cleaning 302.

The recording medium 402 is finally supplied to a fixing station. There the toner images are fixed in a known manner, for example via pressure and/or heat.

FIG. 2 shows a first realization of a developer station 200 without potential image carrier 101. The liquid developer is contained in a reservoir container 205. Liquid developer is supplied to a raster roller 208 with the aid of scoop rollers 206 and 207. The raster roller 208 that is provided with a raster on the surface takes on liquid developer from the scoop roller 207. A scraper 209 rests on the webs of the raster roller 208 and thereby removes excess liquid developer outside of the cups of the raster roller 208. The raster roller 208 passes the liquid developer to the applicator roller 201, which directs the liquid developer onto the potential image carrier 101 for inking of the potential images. The applicator roller 201 is subsequently cleaned by a cleaning device with a cleaning roller 210 and a scraper 211.

FIG. 3 shows a second realization of the developer station 200 without potential image carrier 101. Here a chamber scraper 212 is used in order to supply liquid developer to the raster roller 208. The further transport of the liquid developer to the potential image carrier 101 corresponds to FIG. 2.

The chamber scraper 201 for offset printing is known from Kipphan, “Handbuch der Printmedien”, Springer Verlag, 2000. Its use for electrophoretic digital printing is proposed according to FIG. 3.

The chamber scraper 212 is a chamber 214 sitting on the circumferential surface of the raster roller 208, which chamber 214 is sealed by two scrapers (the closing scraper R1 at the entrance of the chamber 214, viewed in the rotation direction of the raster roller 208; the dosing scraper R2 at the exit of the chamber 214, viewed in the rotation direction of the raster roller 208) and two seals for sealing of the lateral edge of the raster roller 208 (not visible in FIG. 3). The supply of the liquid developer into the chamber 214 of the chamber scraper 212 can occur via one or more inlet openings, advantageously via pumps. The discharge of the liquid developer from the chamber 214 (for example advantageously for better stirring of the liquid developer) and the emptying of the chamber 214 can occur either via inlet or outlet openings. The advantage of the chamber scraper 212 is in particular to be seen in that this can to a large extent be arranged freely along the circumference of the raster roller 208 such that the raster roller 208 can also correspondingly be arranged at various positions on the circumference of the applicator roller 201. The position of the chamber scraper 212 relative to the raster roller 208 is determined in that the dosing scraper R2 should lie below the surface of the liquid developer in the chamber 214; this can be achieved via the force of gravity corresponding to the position of the chamber scraper 212 or via overpressure in the chamber 214.

The raster roller 208 is adapted in terms of its rastering for conveyance of a volume of liquid developer from 1 to 40 cm³/m² (proportional to the roller surface), advantageously 5-20 cm³/m².

The conveyance of liquid developer is additionally proportional to the surface and therewith independent of the print speed, meaning that the same quantity of liquid developer per areal unit of the applicator roller 201 is always supplied at different print speeds.

The applicator roller 201 directs the liquid developer with the properties described above onto the potential image carrier 101. The image locations of the potential images that are present on the potential image carrier 101 are then inked via the toner particles comprised in the liquid developer. An electrical field exists between potential image carrier 101 and applicator roller 201, such that the toner particles in the region of the image locations of the potential images on the potential image carrier 101 migrate; to the contrary toner particles in the remaining regions for the most part do not migrate. The migration occurs in a developer gap 213 existing between applicator roller 201 and potential image carrier 101, the film thickness of which developer gap 213 can be influenced by, for example, the surface material of the applicator roller 201 and the properties of the liquid developer. The developer gap 213 and its length is selected such that the toner particles of the liquid developer ink the image locations of the potential images well. This result can be advantageously influenced via use of an additional electrical field between applicator roller 201 and potential image carrier 101.

An optimal composition of the liquid developer is the following:
viscosity of the liquid developer: 1-99 mPa*s;
viscosity of the liquid developer: 0.1-80 mPa*s;
toner proportion: 10-55%;
toner diameter: average value of the volume-weighted diameter distribution of the toner particles in a range from 0.1-5 μm.

Further requirements for the development:
film thickness in the developer gap: 1-20 μm.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

We claim as our invention:

1-26. (canceled)

27. A device for development of potential images previously generated on a potential image carrier, said potential images comprising images to be printed as image locations, in an electrophotographic printing or copying device, comprising:
an applicator roller that directs a liquid developer comprising carrier fluid and toner particles onto the potential image carrier for inking of the image locations of the potential images such that a developer gap provided between the potential image carrier and the applicator roller is substantially filled; and
a proportion of the toner particles being mixed with the carrier fluid with a viscosity between 0.1 to 80 mPa*s using a dispersion-promoting additive such that the liquid developer has a viscosity between 1-99 mPa*s, so that the toner particles dispersed in the liquid developer in a region of the image locations of the potential images migrate onto the potential image carrier and no toner particles migrate in regions that are not to be developed.

28. A device according to claim 27 in which an entirety of the liquid developer comprising the carrier fluid and the toner particles is executed such that the liquid developer exhibits a viscosity of 1 to <50 mPa*s.

29. A device according to claim 27 in which a proportion of the toner particles in the liquid developer lies between 10-55% by weight.

30. A device according to claim 29 in which an average value of a volume-weighted diameter distribution of the toner particles lies in a range from 0.1 to 5 μm.

31. A device according to claim 27 in which an electrical field is provided between the applicator roller and the potential image carrier.

32. A device according to claim 27 in which a film thickness of the developer gap is established by a surface material of the applicator roller and properties of the liquid developer.

33. A device according to claim 32 in which the applicator roller is arranged relative to the potential image carrier such that the developer gap filled with liquid developer has the film thickness at 1-20 μm.

34. A device according to claim 27 in which the carrier fluid is high-ohmic.

35. A device according to claim 34 in which the carrier fluid exhibits a specific resistance of >=10¹⁰ Ω*cm.

36. A device according to claim 27 in which the carrier fluid comprises a non-volatile fluid.

37. A device according to claim 27 in which the carrier fluid comprises silicon oil.

38. A device according to claim 37 in which the silicon oil comprises polydimethylsiloxane.

39. A device according to claim 36 in which the liquid developer bringing out the image is subjected to a treatment during a printing process or after a printing process such that it is non-volatile.

40. A device according to claim 39 in which the liquid developer is subjected to a treatment of UV radiation.

41. A device according to claim 40 in which the carrier fluid comprises acrylester.

42. A device according to claim 41 in which the treatment occurs with at least one additional substance that transforms the image via polycondensation via moisture from air such that no volatile substances remain therein or such that volatile substances can no longer escape from said image.

43. A device according to claim 27 in which movement directions of surfaces of the potential image carrier and the applicator roller are selectable.

44. A device according to claim 27 in which surface speeds of the potential image carrier and the applicator roller are selectable.

45. A device according to claim 27 in which transport of the liquid developer to the potential image carrier is surface-related and independent of print speed, and that at different print speeds a same quantity of liquid developer per areal unit arrives onto the applicator roller.

46. A device according to claim 27 in which a raster roller that supplies the liquid developer to the applicator roller is arranged adjacent to the applicator roller.

47. A device according to claim 46 in which at least one scoop roller adjacent to the raster roller supplies the liquid developer to the raster roller.

48. A device according to claim 46 in which a chamber scraper with a closing scraper and a dosing scraper is arranged adjacent to the raster roller, the chamber scraper supplying the liquid developer to the raster roller.

49. A device according to claim 48 in which the chamber scraper is arranged relative to the raster roller such that the dosing scraper lies below a surface of the liquid developer.

50. A device according to claim 46 in which the raster roller exhibits a rastering that enables a conveyance of a volume of liquid developer of 1 to 40 cm³/m² relative to a surface of the roller.

51. A method for development of potential images previously generated on a potential image carrier, said potential images comprising images to be printed as image locations, in an electrophotographic printing or copying device, comprising the steps of:
providing a liquid developer comprising carrier fluid and toner particles for inking of the image locations of the potential images; and
mixing a proportion of the toner particles with the carrier fluid with a viscosity between 0.1 to 80 mPa*s using a dispersion-promoting additive such that the liquid developer has a viscosity between 1-99 mPa*s, so that the toner particles dispersed in the liquid developer in a region of the image locations of the potential images migrate onto the potential image carrier and no toner particles migrate in regions that are not to be developed.

52. A method for development of potential images previously generated on a potential image carrier, said potential images comprising images to be printed as image locations, in an electrophotographic printing or copying device, comprising the steps of:
providing an applicator roller that directs a liquid developer comprising carrier fluid and toner particles onto the potential image carrier for inking of the image locations of the potential images such that a developer gap provided between the potential image carrier and the applicator roller is substantially filled; and
mixing a proportion of the toner particles with the carrier fluid with a viscosity between 0.1 to 80 mPa*s using a dispersion-promoting additive such that the liquid developer has a viscosity between 1-99 mPa*s, so that the toner particles dispersed in the liquid developer in a region of the image locations of the potential images migrate onto the potential image carrier and no toner particles migrate in regions that are not to be developed.
